(19) United States
(12) Patent Application Publication
(10) Pub. No.: US 2024/0020605 A1
(43) Pub. Date: Jan. 18, 2024

(54) CLOUD RESOURCE MANAGEMENT

(71) Applicant: Twitter, Inc., San Francisco, CA (US)

(72) Inventor: Saurabh Ravindra Deochake, Boulder, CO (US)

(21) Appl. No.: 17/863,116

(22) Filed: Jul. 12, 2022

(51) Int. Cl. G06Q 10/06

(52) U.S. Cl. CPC G06Q 10/06315; G06F 9/45558

(57) ABSTRACT

Methods, systems, and apparatus, including computer programs encoded on computer storage media, for managing cloud resources. One of the methods includes determining a computer resource to acquire from a cloud system for a first service, and first data comprising i) a first time period within which to acquire the computer resource and ii) a first urgency of the computer resource for the first service; posting, to a message queue, the first data; accessing, from the message queue, second data of a second agent comprising i) a second time period within which to acquire the computer resource for a second service, and ii) a second urgency of the computer resource for the second service; determining, whether to withdraw a first request for the computer resource; responsive to determining not withdraw the first request, determining an updated request; and upon acceptance of the updated request, acquiring the computer resource.

### BACKGROUND

This specification relates to cloud resource management.

### SUMMARY

An entity, such as an enterprise, can have multiple computer-implemented agents. Each computer-implemented agent can be assigned an infrastructure service for the enterprise. Multiple agents managing multiple services can autonomously expand the infrastructure footprint by acquiring necessary cloud resources from cloud resource systems.

When multiple agents from the same entity request the same computer resource from the same cloud resource system, they may be in a conflicting situation where two or more agents from the same entity, e.g., enterprise, try to compete with each other for the same computer resource. An unwanted side-effect of such a situation is that the overall cost for the entity can increase due to agents self-competing with each other.

To avoid self-competing, the multiple agents can form an alliance and share their data with each other. A computer-implemented agent can post its own data in a message queue regarding acquiring the computer resource, and access data of other participating agents from the message queue. The computer-implemented agent can use its own data and other agents' data to determine whether to withdraw its request for the computer resource, or how to update its request, or both. In the meantime, the computer-implemented agent can minimize the overall cost incurred to the entity.

In general, one aspect of the subject matter described in this specification can be embodied in methods that include the actions of determining, by a first computer-implemented agent that manages a first service provided by an entity, a computer resource to acquire from a cloud resource system for the first service, and first data comprising i) a first time period within which to acquire the computer resource and ii) a first urgency of the computer resource for the first service; posting, to a message queue for the first computer-implemented agent and a second computer implemented agent both of which a) are requesting access to the computer resource on the cloud resource system and b) manage corresponding services provided by the entity, the first data; accessing, from the message queue, second data of the second computer-implemented agent comprising i) a second time period within which the second computer-implemented agent should acquire the computer resource for a second service provided by the entity, and ii) a second urgency of the computer resource for the second service; determining, by the first computer-implemented agent and using the first data and the second data, whether to withdraw a first request for the computer resource; in response to determining to not withdraw the first request for the computer resource for the first service, determining an updated request for the computer resource using the first data and the second data; and upon acceptance of the updated request for the computer resource, acquiring the computer resource for use by the first service.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the method can include sending, to the cloud resource system and using data indicating the computer resource for the first service, the first request for the computer resource for use by the first service; and in response to sending the first request for the computer resource for the first service, receiving a notification that the second computer-implemented agent that manages the second service provided by the entity requested the computer resource for the second service. In some implementations, the method can include continuously monitoring a current status of resource utilization for the first service; and in response to determining that the current status of resource utilization satisfies a threshold, sending the first request for the computer resource to the cloud resource system.

In some implementations, the method can include determining, by the first computer-implemented agent and using the first data and the second data, whether to withdraw a first request for the available computer resource; and in response to determining to withdraw the first request for the computer resource for the first service, determining to not post an additional message to the message queue and to remove the first request for the available computer resource from the cloud resource system.

In some implementations, the method can include determining, by the first computer-implemented agent, a behavior cooperation value of the first computer-implemented agent using i) the first time period within which to acquire the computer resource, ii) the first urgency of the computer resource for the first service, and iii) a cost change between a cost value in a current round of negotiation and a cost value in a previous round of negotiation for the computer resource.

In some implementations, the method can include determining, by the first computer-implemented agent, whether a threshold time period within which to acquire the computer resource is satisfied, wherein the first time period was initially determined using the threshold time period; and in response to determining that the threshold time period is satisfied, terminating negotiation for acquiring the computer resource.

In some implementations, the method can include minimizing an overall cost incurred within the entity using the first data and the second data.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various embodiments and may result in one or more of the following advantages. In some implementations, the systems and methods described in this specification can minimize or avoid self-competition among multiple agents from the same entity. In some implementations, the systems and methods described in this specification can reduce, or minimize the overall cost for the entity. In some implementations, because participating agents can cooperate with each other by sharing their data in a message queue, the systems and methods described in this specification can enable the agents to determine and update their requests more efficiently using more data than previously available. In some implementations, because each agent can post the updated requests and updated resource acquiring status data in the message queue, the systems and methods described in this document can lead to faster acquisition of computer resources, reduced computer resource usage required to acquire the computer resources, or both.

In some implementations, posting the updated request and the updated resource acquiring status data in the message queue can cause other participating agents to stop submitting requests, which can save computational resources for the participating agents and the entity.

In some implementations, the systems and methods described in this specification can enable each computer-implemented agent to autonomously augment its data center infrastructure with cloud infrastructure by acquiring and releasing cloud resources from cloud resource systems. In some implementations, the computer-implemented agent can release over-provisioned cloud resources by returning extra cloud resources back to the cloud resource system, which can optimize the cost for the computer-implemented agent. In some implementations, the systems and methods described in this specification can enable each computer-implemented agent to manage its infrastructure in an elastic way, e.g., by constantly acquiring and releasing cloud resources based on real-time infrastructure resource requirements.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example of an entity infrastructure that includes multiple computer-implemented agents for cloud resource management.

FIG. 2 is an example computing environment for cloud resource management.

FIG. 3 is a flow diagram of an example process for managing cloud resources.

Like reference numbers and designations in the various drawings indicate like elements.

### DETAILED DESCRIPTION

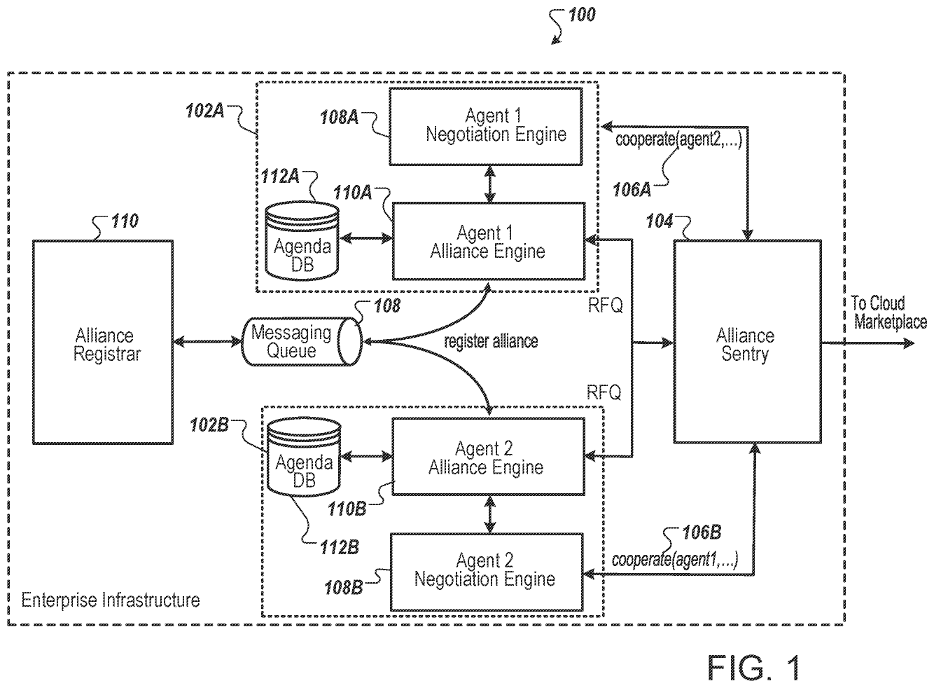

FIG. 1 is an example of an entity infrastructure 100 that includes multiple computer-implemented agents for cloud resource management. The entity can be an enterprise or any other organization. Each computer-implemented agent (also referred to as agent) 102A and 102B (collectively referred to as 102) can manage a particular service provided by the entity. For example, agent 1 102A can be a computer in an information technology (IT) department that manages the IT service of the entity. Agent 2 102B can be a computer in another department that manages the application deployment of the entity. Each computer-implemented agent can include a negotiation engine 108A and 108B (collectively referred to as 108), an alliance engine 110A and 110B (collectively referred to as 110), and an agenda database 112A and 112B (collectively referred to as 112).

Each computer-implemented agent 102 can manage the computer resources for the corresponding particular service of the entity. The computer resources can include infrastructure resources, components, and any other computer resources. The computer resources can include local computer resources, cloud computer resources obtained from one or more cloud resource systems, or both. Some examples of computer resources include computer processors, memory, computation time, types of processors, virtual machines, persistent disc size for a virtual machine, or a combination of two or more of these.

The computer-implemented agent 102 can use a resource monitor to continuously monitor the current status of the respective computer resources that are used to support the particular service of the computer-implemented agent 102. The monitored current status can include a resource utilization level and a resource availability of each computer resource. If the current status satisfies a threshold, the computer-implemented agent 102 can determine to acquire additional computer resources from cloud resource systems. For example, the monitored current status can indicate that the service has used 80% of the available virtual machines, and that only 20% of the available virtual machines are left for the service. In this example, when the threshold is 80%, the computer-implemented agent may determine to acquire additional virtual machine resource from cloud resource systems.

The computer-implemented agent 102 can issue a request for the to-be-acquired computer resource. The computer-implemented agent 102 can send the request through an alliance sentry 104. The request can include the identity of the computer-implemented agent, the data indicating the computer resource to be acquired, such as parameters and attributes of the computer resource, or both.

After receiving different requests from different agents for the same entity, the alliance sentry 104 can match the requests that contain the same parameters for the computer resource. The alliance sentry 104 can determine that such requests are for acquiring the same computer resource. The alliance sentry 104 can determine that the different agents are self-competing with each other. The alliance sentry 104 can send a notification to each participating agent to inform them that they are self-competing and instruct each participating agent to form an “alliance” and cooperate with other participating agents for the same entity. For example, the alliance sentry 104 can determine that agent 1 102A and agent 2 102B are self-competing. The alliance sentry 104 can send a notification 106A to agent 1 instructing agent 1 to cooperate with agent 2. The alliance sentry 104 can send a notification 106B to agent 2 instructing agent 2 to cooperate with agent 1.

The notification 106 can include a mailbox identifier (ID) for a message queue 108. The message queue 108 can be used by different computer-implemented agents 102 from the same entity, e.g., enterprise, to share information with each other. Each participating agent 102 can receive the notification and post their resource acquiring status data in the message queue 108 using the mailbox ID.

Each computer-implemented agent 102 can include a negotiation engine, an alliance engine, and an agenda database. The negotiation engine can receive the cooperation notification 106 from the alliance sentry 104. After receiving the cooperation notification 106 from the alliance sentry 104, the negotiation engine can instruct the alliance engine to register with alliance registrar 110 to form an alliance with other participating agents. After forming the alliance with other agents that are from the same entity and require the same computer resource, each computer-implemented agent 102 can post their own resource acquiring status data in the message queue 108 to share with other agents. The resource acquiring status data can include the offer made by the respective agent, a time period within which to acquire the computer resource, the urgency of a need for the computer resource for the respective service of each agent, and any other relevant data. Each computer-implemented agent 102 can determine whether to withdraw its request, how to update its request, or both, based on the data shared by other agents, so as to avoid self-competing.

The agenda database 112 can store the metadata about all the participating agents and the negotiation space an agent belongs to, such as the cost the agent is willing to spend. For instance, each agent can use the corresponding agenda database to determine how to fulfill the requirements of all the important issues for the computer resource and within the confine of the cost that the agent can spend.

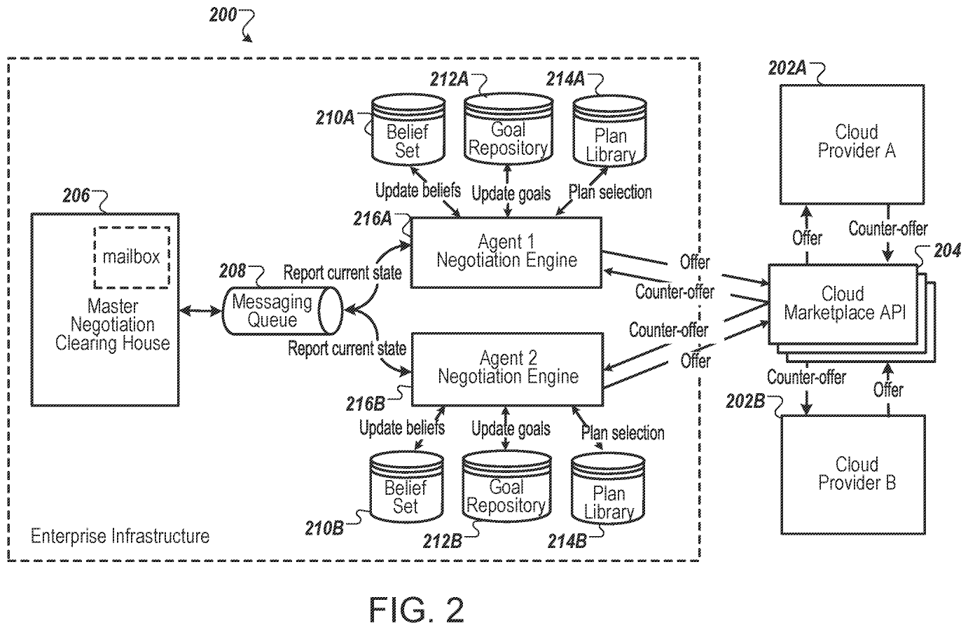

FIG. 2 is an example computing environment 200 for cloud resource management. The computing environment 200 can include one or more agent devices that acquire computer resources from cloud resource systems, such as cloud providers 202A and 202B (collectively referred to as 202) through cloud marketplace application programming interface (API) 204.

Once the alliance sentry, e.g., the alliance sentry 104, detects a competing alliance involving two or more agents, all involved agents can perform every subsequent negotiation round while coordinating with each participating agent. A master negotiation clearing house 206 can use a mailbox message passing model for the participating agents to share messages. Although this specification refers to a mailbox, any appropriate message passing model can be used for the participating agents to share messages. Each computer-implemented agent can share every negotiation transaction message in subsequent rounds to the master negotiation clearing house 206 with other participating agents. The master negotiation clearing house 206 can include the message queue 208 including the messages from each agent. The message from each agent can include the respective data of each agent regarding acquiring the computer resource or resources for its respective service.

Each agent can be a Belief-Desire-Intention (BDI) agent that has three database systems that store the agent's beliefs, goals, and plans. The beliefs can be an agent's understanding about the current negotiation round for the computer resource. For example, the beliefs can include the metadata of the other agents, such as the time period within which other agents should acquire the computer resource, the urgency of the computer resource for the services of other agents, the behavior cooperation values of other agents, and the like. The beliefs can be stored in the belief set database 210A, 210B (collectively referred to as 210) of the respective computer-implemented agent. The goals can be an agent's ruminative intentions to reach an agreement over a negotiation on a particular computer resource. For example, the goals can include the utility value of the computer resource for the agent, the cost value of the computer resource, and the like. With each round of negotiation, the agent can update its goals to determine whether the cost value is within a threshold. The goals can be stored in the goal repository 212A and 212B (collectively referred to as 212) of the respective computer-implemented agent. A plan can be a set of instructions to carry out to fulfill the ruminative intention of achieving a goal. For example, the plan can include a specific set of offers and counter-offers to be submitted in a negotiation process. The plan can be stored in the plan library 214A and 214B (collectively referred to as 214) of the respective computer-implemented agent.

Each computer-implemented agent can include a negotiation engine 216A and 216B (collectively referred to as 216) that reports its current resource acquiring status data in the message queue 208 and accesses other agents' data from the message queue 208. With every round of negotiation, the negotiation engine 216 of each agent can update the beliefs in the belief set database 210 based on the other agents' data. The negotiation engine 216 of each agent can update the goals in the goal repository 212 based on the other agents' data. After updating the beliefs and goals, the negotiation engine 216 can update its request, such as updating its offer posted to the message queue 208. The negotiation engine 216 can further select the plans such as submitting offers or counter-offers using the beliefs, goals, or both, for the current round of negotiation.

For example, each computer-implemented agent can use the negotiation engine 216 to report its current resource acquiring status data, such as the time period within which to acquire the computer resource, the urgency of the computer resource in the current round of negotiation, into the message queue 208. The computer-implemented agent can access other agents' resource acquiring status data from the message queue 208. The computer-implemented agent can update its beliefs in the belief set database 210 based on the other agents' data to have a better understanding about the current negotiation round for the computer resource. After accessing the other agents' resource acquiring status data, the computer-implemented agent can use the negotiation engine 216 to update its goals in the goal repository 212, such as the utility value and the cost value of the computer resource. The computer-implemented agent can update the request for the computer resource, e.g., the offer for the computer resource. The computer-implemented agent can use the negotiation engine 216 to select the plans such as submitting offers or counter-offers. In some implementations, the computer-implemented agent can determine whether to withdraw the request for the computer resource.

The computer-implemented agent can be a single server computer or multiple server computers operating in conjunction with one another, including, for example, a set of remote computers deployed as a cloud computing service. The computer-implemented agent can include several different functional components, including a negotiation engine, and an alliance engine. The negotiation engine, or alliance engine, or a combination of these, can include one or more data processing apparatuses, can be implemented in code, or a combination of both. For instance, each of the negotiation engine and the alliance engine can include one or more data processors and instructions that cause the one or more data processors to perform the operations discussed herein.

The various functional components of the computer-implemented agent can be installed on one or more computers as separate functional components or as different modules of a same functional component. For example, the components negotiation engine and alliance engine of the computer-implemented agent can be implemented as computer programs installed on one or more computers in one or more locations that are coupled to each through a network. In cloud-based systems, for example, these components can be implemented by individual computing nodes of a distributed computing system

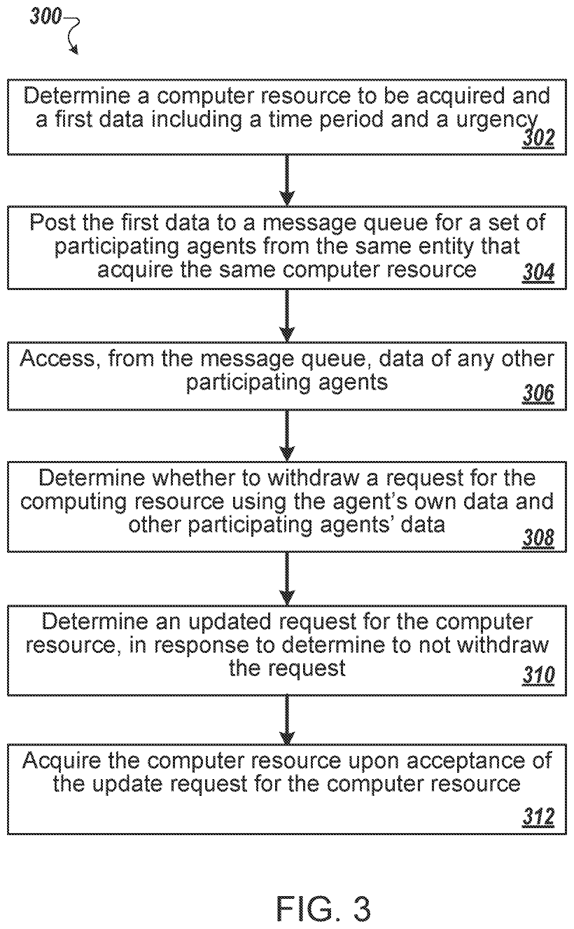

FIG. 3 is a flow diagram of an example process 300 for managing cloud resources. For example, the process 300 can be used by the agent device 102 from the entity infrastructure 100.

At step 302, a computer-implemented agent can determine a computer resource to be acquired from a cloud resource system for a first service and determine a first data of resource acquiring status, such as a time period within which to acquire the computer resource, and an urgency of the computer resource for the first service. The first service can be provided by an entity and assigned to the computer-implemented agent. For example, the computer-implemented agent can be a department, such as IT (information technology) department, of an enterprise that manages the IT service for the enterprise.

The computer-implemented agent can manage the computer resources for the particular service, also referred to as first service, assigned to the computer-implemented agent. The computer resources can include infrastructure resources, components, and any other computer resources. The computer resources can include local computer resources, or cloud computer resources obtained from one or more cloud resource systems, or both. The computer-implemented agent can include a resource monitor to continuously monitor a current status of resource utilization, such as the resource utilization of the infrastructure services and components, and any other computer resources that are used to support the particular service of the computer-implemented agent.

In response to determining that the current status of resource utilization satisfies a threshold, the computer-implemented agent can send a request for additional computer resources to a cloud resource system. Based on the monitored current status of the computer utilization for supporting the particular service, the computer-implemented agent can determine the computer resource to be acquired from the cloud resource system for the service. The monitored current status can include a resource utilization level and a resource availability of each computer resource. For example, the monitored current status can indicate that the service has used 80% of the available virtual machines, and that only 20% of the available virtual machines are left for the service.

If the current status satisfies a threshold, the computer-implemented agent can determine to acquire additional computer resources from cloud resource systems. For example, if a resource availability for the service, such as virtual machines, satisfies a threshold, the computer-implemented agent can determine to acquire more of those resources from cloud resource systems. For instance, when the resource utilization level of the virtual machines reaches 80% or more than 80%, or the resource availability of the virtual machines reaches 20% or less than 20%, the computer-implemented agent can determine to acquire additional virtual machine resources from cloud resource systems. In these examples, the threshold can be 80% for resource utilization or 20% for resource availability. In some implementations, the threshold can be set by the computer-implemented agent, or the entity, e.g., the enterprise. In some implementations, the computer-implemented agent can determine to release extra computer resources if the monitored current status shows that the resource availability of certain computer resources satisfies a threshold, e.g., the resource availability is higher than a threshold.

The computer-implemented agent can determine a set of resource acquiring status data, e.g., first data, regarding the computer resource to be acquired from cloud resource systems. The set of resource acquiring status data can include a time period within which to acquire the computer resource and an urgency of the computer resource for the service.

The resource acquiring status data can include the time period within which to acquire the computer resource. The time period within which to acquire the computer resource can include the left time for the computer-implemented agent to acquire the computer resource. The computer-implemented agent is required to acquire the computer resource within a threshold time period. For example, the threshold time period within which to acquire the computer resource can be a total amount of time for negotiation with the cloud resource systems. The time left to acquire the computer resource, e.g., the time period within which to acquire the computer resource, was initially determined using the threshold time period. For instance, the threshold time period can be 10 minutes. Initially, the time left to acquire the computer resource is the same as the threshold time period. As the negotiation process goes on, the time left to acquire the computer resource can decrease. Assuming that the computer-implemented agent may have consumed 8 minutes in the negotiation process, the time left for the computer-implemented agent to acquire the computer resource is 2 minutes.

The resource acquiring status data can include the urgency of the computer resource for the service. The urgency of the computer resource for the service can be the resource utilization level of the computer resource, or the resource availability of the computer resource. The more computer resource the service has utilized, the fewer computer resource left for use, the more quickly the service is using up the computer resources, or a combination of these, the more urgently the computer-implemented agent needs to acquire additional computer resources from the cloud resource systems.

In some implementations, the computer-implemented agent can determine a utility value of an offer made by the computer-implemented agent. The utility value can be a combination of a weight value of each attribute of the to-be-acquired computer resource, a cost value, and an amount of time consumed to acquire the computer resource. In some examples, the utility value represents a positive correlation with the weight value, the cost value, and the amount of time. The weight value of each attribute can indicate an importance of the attribute for the computer-implemented agent. The cost value can be a value the computer-implemented agent can afford. For example, the cost value can be a monetary value offered by the computer-implemented agent for the computer resource. The cost value can be within a range of acceptable values. The amount of time consumed to acquire the computer resource can be obtained using the time period within which to acquire the computer resource. The time period within which to acquire the computer resource can be an amount of remaining time for the computer-implemented agent to acquire the computer resource. For example, the threshold time period can be 10 minutes for negotiation with the cloud resource systems. Assuming that the remaining time for the computer-implemented agent to acquire the computer resource is 2 minutes, computer-implemented agent has consumed 8 minutes in the negotiation process.

At step 304, the computer-implemented agent can post the set of resource acquiring status data, e.g., first data, to a message queue for the computer-implemented agent and other computer implemented agents. In some implementations, in addition to the time period within which to acquire the computer resource, and an urgency of the computer resource for the service, the computer-implemented agent can post its current offer, the utility of the offer, and other resource acquiring status data.

The message queue can be shared using a mailbox or a message pool or any other appropriate message passing model. The message queue can be a first in first out (FIFO) message queue. The message queue can be used by a set of participating agents from the same entity, e.g., enterprise, that acquires the same computer resource. For example, the computer-implemented agent, e.g., agent 1, and another computer-implemented agent, e.g., agent 2, can both be requesting access to the same computer resource on the same cloud resource system. The two computer-implemented agents, e.g., agent 1 and agent 2, can be both from the same entity and manage corresponding services provided by the entity. For instance, agent 1 can manage the IT service of the entity, and agent 2 can manage the application deployment service of the entity.

When agent 1 and agent 2 are both from the same entity and requesting the same computer resource from the same cloud resource system, they may be in a conflicting situation where two or more agents from the same entity, e.g., enterprise, try to compete with each other for the same computer resource. An unwanted side-effect of such a situation is that the overall cost for the entity can increase due to agents self-competing with each other. To avoid self-competing, the multiple agents can form an alliance can post their resource acquiring status data to the message queue to share the data with other agents in the alliance. In some implementations, the systems and methods described in this specification can minimize or avoid self-competition among multiple agents from the same entity. In some implementations, by reducing or avoiding self-competition within the same entity, the systems and methods described in this specification can reduce or minimize the overall cost for the entity, the computational resources used by the agents to acquire the computer resources, or both.

In some implementations, an alliance sentry included in the enterprise infrastructure of the entity can identify the multiple agents from the entity that are self-competing for the same computer resource. The computer-implemented agent can send a request for the computer resource for its particular service, e.g., the first service. The computer-implemented agent can send the request to a cloud resource server through the alliance sentry. The request can include the identity of the computer-implemented agent, the data indicating the computer resource to be acquired, such as parameters and attributes of the computer resource. After receiving different requests from different agents within the same entity, the alliance sentry can match the requests that contain the same parameters for the computer resource. The alliance sentry can determine that such requests are for acquiring the same computer resource. The alliance sentry can determine that the different agents are self-competing with each other. The alliance sentry can send a notification to each participating agent to inform them that they are self-competing and instruct each participating agent to form an alliance.

In response to sending the request for the computer resource for the first service, the computer-implemented agent can receive the notification that a second computer-implemented agent that manages a second service provided by the entity requested the same computer resource for the second service. For example, agent 1 can receive the notification that agent 2 managing the application deployment service of the entity also requested the same computer resource.

The notification can include a mailbox identifier (ID) for the message queue. Each participating agent can receive the notification and post their resource acquiring status data in the message queue using the mailbox ID.

At step 306, the computer-implemented agent can access, from the message queue, data of any other participating computer-implemented agents, such as second data of agent 2. The second data includes the time period within which agent 2 should acquire the computer resource for another service, e.g., a second service, assigned to agent 2, and the urgency of the computer resource for that service. Each computer-implemented agent can be required to acquire the computer resource within a respective threshold time period.

At step 308, the computer-implemented agent can determine whether to withdraw the request for the computer resource using its own data and other participating agents' data. For example, if agent 1 has 2 minutes to acquire the computer resource, and 20% of available computer resource left for use; agent 2 has 5 minutes to acquire the computer resource, and 50% of available computer resource left for use, agent 1 can decide that agent 2 needs the computer resource less urgently. Agent 1 can decide to not withdraw its request. Agent 2 can decide to withdraw its request.

In some implementations, the participating agents in the alliance can attempt to coordinate with each other to attempt to reach their goals while minimizing the overall cost incurred to the entity, e.g., enterprise. The computer-implemented agent can comprise its own goal based on the data shared by other participating agents.

In some implementations, the computer-implemented agent can determine a behavior cooperation value for each participating agent, and determine whether to withdraw the request based on the calculated behavior cooperation value. In some implementations, each computer-implemented agent can determine its own behavior cooperation value and post its behavior cooperation value in the message queue.

The behavior cooperation value can dictate the agent's behavior while cooperating with other agents in the alliance. The larger the behavior cooperation value, more likely the agent will comprise its goals and be a conceder during the negotiation with the cloud resource systems.

The behavior cooperation value A can be calculated using equation (1) below, using a cost change in the current round compared to the previous round of negotiation, the time period within which to acquire the computer resource, and the urgency of the computer resource.

λᵢ=Δcᵢ*μᵢ*tᵢ (1)

The cost change Δcᵢ can be obtained using the equation (2), below, where cᵢ is the cost value of the current round of negotiation for the computer resource, and cᵢ₋₁ is the cost value of the previous round of negotiation for the computer resource. The behavior cooperative value can be positively correlated with the cost change.

$$Δ {c}_{i} = \frac{{c}_{i} - {c}_{i - 1}}{{c}_{i - 1}} \qquad ( 2 )$$

The time period tᵢ within which to acquire the computer resource can be the relative time remaining in the current negotiation. Based on the time period within which to acquire the computer resource, the amount of time that has been consumed for acquiring the computer resource can be determined. For example, the threshold time period can be 10 minutes for negotiation with the cloud resource systems. Assuming that the remaining time for the computer-implemented agent to acquire the computer resource is 2 minutes, computer-implemented agent has consumed 8 minutes in the negotiation process. The behavior cooperative value can be positively correlated with the amount of time that has been consumed for acquiring the computer resource. The more time that has been consumed, the higher urgency for the computer-implemented agent to conclude the negotiation.

The urgency of the computer resource pi can be determined using the resource utilization for the service. The larger value of the resource utilization, the higher urgency for the computer-implemented agent to conclude the negotiation.

Each participating agent can have an initial threshold value for the behavior cooperation value. As the negotiation progresses for each agent, a new behavior cooperation value can be calculated. The new behavior cooperation value is compared against the initial threshold value. If the new behavior cooperation value is smaller than the initial threshold value, the corresponding agent tends to be headstrong. If the new behavior cooperation value is equal to the initial threshold value, the corresponding agent tends to be linear. If the new behavior cooperation value is larger than the initial threshold value, the corresponding agent tends to be a conceder.

In some implementations, in addition to the time period within which to acquire the computer resource and the urgency of the computer resource for the service, each agent can post the utility value, the offer including the cost value, the behavior cooperation value, or a combination of these, in the message queue.

At step 310, the computer-implemented agent can determine an updated request for the computer resource, in response to determine to not withdraw its request for the computer resource for the service. For example, the computer-implemented agent can increase or decrease its offer, or use the previous offer. The computer-implemented agent can update the request using its own data and the data shared by other participating agents, while minimizing the overall cost incurred to the entity. After updating the request, the computer-implemented agent can post the updated request and updated resource acquiring status data in the message queue for a new round of negotiation within the alliance. Accessing data of other participating agents from the message queue and determining whether to withdraw the request using the agent's own data and other agents' data are part of a round of negotiation for the computer resource within the alliance.

In some implementations, because the participating agents can cooperate with each other by sharing their data in a message queue, the systems and methods described in this specification can enable the agents to determine and update their requests more efficiently using more data than previously available, fewer computational resources across multiple rounds of negotiation, or both. In some implementations, because the agents can post the updated request and the updated resource acquiring status data in the message queue, the systems and methods described in this document can lead to faster acquisition of the computer resources, reduced computer resource usage required to acquire the computer resources, or both.

In response to determining to withdraw the request for the computer resource for the service, the computer-implemented agent can determine to not post an additional message to the message queue and to remove the request for the computer resource from the cloud resource system. In some implementations, because the computer-implemented agent can withdraw the request, the systems and methods described in this document can save resources and energy by restraining the computer-implemented agent from competing with other participating agents from the same entity. In some implementations, because the computer-implemented agent can withdraw the request, the systems and methods described in this document can enable reduced burden on computational resources of the computer-implemented agent. In some implementations, because the updated request and the updated resource acquiring status data are posted in the message queue, the systems and methods described in this document can cause other participating agents to stop submitting requests, which can save computational resources for the other participating agents and the entity.

With every new negotiation round, an agent can post a message with its offer, the utility of the offer, and other resource acquiring status data, such as the time period within which to acquire the computer resource, and an urgency of the computer resource for the service. Once an agent posts the message in the message queue, other participating agents can treat the message about the current negotiation round as new belief, calculate goals for their offers and construct new plans, and modify the old plans. Such steps are executed continuously until all other participating agents leave the alliance one by one and only one agent is left requesting the resource.

In some implementations, the computer-implemented agent can determine whether to withdraw the request, or how to update the request, or both, considering the behavior cooperation value of the participating agents. As discussed above, the behavior cooperation value can indicate whether the corresponding agent is headstrong, conceder or linear, e.g., neutral, neither headstrong nor conceder. The computer-implemented agent can use such information about other participating agents to determine whether to withdraw the request, or how to update the request, or both.

At step 312, the computer-implemented agent can acquire the computer resource for its service upon acceptance of the update request for the computer resource.

When negotiating, the computer-implemented agent can determine an offer Oᵢ^{t}^{ₙ₋₁} for computer resource i at time tₙ₋₁, where n is an integer corresponding to the negotiation round. The offer Oᵢ^{t}^{ₙ₋₁} can be determined given a utility Uᵢ of the offer. The computer-implemented agent can determine the utility Uᵢ using the computer-implemented agent's goals, beliefs, plans, or a combination of these.

In addition to negotiating with other participating agents from the same entity, the computer-implemented agent a also engages in a negotiation with an opponent cloud resource system b for computer resource i. The computer-implemented agent can determine whether to acquire the computer resource from the cloud resource system by comparing the utility Uᵢ (Oᵢ_{_{b→a}}^{t}^{ₙ}) of the updated offer Oᵢ_{_{a→b}}^{t}^{ₙ} and the utility Uᵢ (Oᵢ_{_{b→a}}^{t}^{ₙ₋₁}) of a previous offer Oᵢ_{_{b→a}}^{t}^{ₙ₋₁} that is received by the opponent cloud resource system. The agent a can determine a response R using equation (3), below. In some examples, the response can be one of three results.

$$R = \{ \begin{matrix}acquire ( a , b , {O}_{i}^{{t}_{n - 1}} ) , if {U}_{i} ( {O}_{{i}_{a \to b}}^{{t}_{n}} ) \leq {U}_{i} ( {O}_{{i}_{b \to a}}^{{t}_{n - 1}} ) \\ terminate ( a , b ) , if t > {t}_{max} \\ counter ( a , b , {O}_{{i}_{a \to b}}^{{t}_{n}} ) , otherwise\end{matrix} \qquad ( 3 )$$

If the utility Uᵢ (Oᵢ_{_{a→b}}^{t}^{ₙ}) of the updated offer Oᵢ_{_{a→b}}^{t}^{ₙ} is greater than the utility Uᵢ (Oᵢ_{_{b→a}}^{t}^{ₙ₋₁}) of the previous offer Oᵢ_{_{b→a}}^{t}^{ₙ₋₁} received by the opponent cloud resource system, the computer-implemented agent can send a counter-offer counter (a, b, Oᵢ_{_{a→b}}^{t}^{ₙ}) to the opponent cloud resource system with the updated offer Oᵢ_{_{a→b}}^{t}^{ₙ}, e.g., modified cost value; otherwise, the computer-implemented agent can determine to acquire the computer resource using the previous offer acquire (a, b, Oᵢ^{t}^{ₙ₋₁}) The computer-implemented agent can determine whether the threshold time period within which to acquire the computer resource is satisfied. In response to determine that the threshold time period is satisfied, e.g., t>tₘₐₓ, the computer-implemented agent can terminate the negotiation terminate (a, b) for acquiring the computer resource. For example, the computer-implemented agent can determine whether the threshold time period is reached. Assuming that the threshold time period is 10 minutes, if the updated offer is obtained beyond the threshold time period, e.g., 10 minutes, the computer-implemented agent can terminate the negotiation round by sending a termination message to the opponent cloud resource system.

The order of steps in the process 300 described above is illustrative only, and 300 can be performed in different orders. In some implementations, the process 300 can include additional steps, fewer steps, or some of the steps can be divided into multiple steps. For example, the step of determining the computer resource to acquire from a cloud resource system can include monitoring the current status of the resources usage for supporting a particular service, and determining that the current status of the resource usage satisfies a threshold.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A computer-implemented method comprising:
determining, by a first computer-implemented agent that manages a first service provided by an entity, a computer resource to acquire from a cloud resource system for the first service, and first data comprising i) a first time period within which to acquire the computer resource and ii) a first urgency of the computer resource for the first service;
posting, to a message queue for the first computer-implemented agent and a second computer implemented agent both of which a) are requesting access to the computer resource on the cloud resource system and b) manage corresponding services provided by the entity, the first data;
accessing, from the message queue, second data of the second computer-implemented agent comprising i) a second time period within which the second computer-implemented agent should acquire the computer resource for a second service provided by the entity, and ii) a second urgency of the computer resource for the second service;
determining, by the first computer-implemented agent and using the first data and the second data, whether to withdraw a first request for the computer resource;
in response to determining to not withdraw the first request for the computer resource for the first service, determining an updated request for the computer resource using the first data and the second data; and
upon acceptance of the updated request for the computer resource, acquiring the computer resource for use by the first service.

2. The method of claim 1, comprising:
sending, to the cloud resource system and using data indicating the computer resource for the first service, the first request for the computer resource for use by the first service; and
in response to sending the first request for the computer resource for the first service, receiving a notification that the second computer-implemented agent that manages the second service provided by the entity requested the computer resource for the second service.

3. The method of claim 2, comprising:
continuously monitoring a current status of resource utilization for the first service; and
in response to determining that the current status of resource utilization satisfies a threshold, sending the first request for the computer resource to the cloud resource system.

4. The method of claim 1, comprising:
determining, by the first computer-implemented agent and using the first data and the second data, whether to withdraw the first request for the computer resource; and
in response to determining to withdraw the first request for the computer resource for the first service, determining to not post an additional message to the message queue and to remove the first request for the computer resource from the cloud resource system.

5. The method of claim 1, comprising:
determining, by the first computer-implemented agent, a behavior cooperation value of the first computer-implemented agent using i) the first time period within which to acquire the computer resource, ii) the first urgency of the computer resource for the first service, and iii) a cost change between a cost value in a current round of negotiation and a cost value in a previous round of negotiation for the computer resource.

6. The method of claim 1, comprising:
determining, by the first computer-implemented agent, whether a threshold time period within which to acquire the computer resource is satisfied, wherein the first time period was initially determined using the threshold time period; and
in response to determining that the threshold time period is satisfied, terminating negotiation for acquiring the computer resource.

7. The method of claim 1, comprising:
minimizing an overall cost incurred within the entity using the first data and the second data.

8. A non-transitory computer storage medium encoded with instructions that, when executed by one or more computers, cause the one or more computers to perform operations comprising:
determining, by a first computer-implemented agent that manages a first service provided by an entity, a computer resource to acquire from a cloud resource system for the first service, and first data comprising i) a first time period within which to acquire the computer resource and ii) a first urgency of the computer resource for the first service;
posting, to a message queue for the first computer-implemented agent and a second computer implemented agent both of which a) are requesting access to the computer resource on the cloud resource system and b) manage corresponding services provided by the entity, the first data;
accessing, from the message queue, second data of the second computer-implemented agent comprising i) a second time period within which the second computer-implemented agent should acquire the computer resource for a second service provided by the entity, and ii) a second urgency of the computer resource for the second service;
determining, by the first computer-implemented agent and using the first data and the second data, whether to withdraw a first request for the computer resource;
in response to determining to not withdraw the first request for the computer resource for the first service, determining an updated request for the computer resource using the first data and the second data; and
upon acceptance of the updated request for the computer resource, acquiring the computer resource for use by the first service.

9. The non-transitory computer storage medium of claim 8, wherein the operations comprise:
sending, to the cloud resource system and using data indicating the computer resource for the first service, the first request for the computer resource for use by the first service; and
in response to sending the first request for the computer resource for the first service, receiving a notification that the second computer-implemented agent that manages the second service provided by the entity requested the computer resource for the second service.

10. The non-transitory computer storage medium of claim 9, wherein the operations comprise:
continuously monitoring a current status of resource utilization for the first service; and
in response to determining that the current status of resource utilization satisfies a threshold, sending the first request for the computer resource to the cloud resource system.

11. The non-transitory computer storage medium of claim 8, wherein the operations comprise:
determining, by the first computer-implemented agent and using the first data and the second data, whether to withdraw the first request for the computer resource; and
in response to determining to withdraw the first request for the computer resource for the first service, determining to not post an additional message to the message queue and to remove the first request for the computer resource from the cloud resource system.

12. The non-transitory computer storage medium of claim 8, wherein the operations comprise:
determining, by the first computer-implemented agent, a behavior cooperation value of the first computer-implemented agent using i) the first time period within which to acquire the computer resource, ii) the first urgency of the computer resource for the first service, and iii) a cost change between a cost value in a current round of negotiation and a cost value in a previous round of negotiation for the computer resource.

13. The non-transitory computer storage medium of claim 8, wherein the operations comprise:
determining, by the first computer-implemented agent, whether a threshold time period within which to acquire the computer resource is satisfied, wherein the first time period was initially determined using the threshold time period; and
in response to determining that the threshold time period is satisfied, terminating negotiation for acquiring the computer resource.

14. The non-transitory computer storage medium of claim 8, wherein the operations comprise:
minimizing an overall cost incurred within the entity using the first data and the second data.

15. A system comprising one or more computers and one or more storage devices on which are stored instructions that are operable, when executed by the one or more computers, to cause the one or more computers to perform operations comprising:
determining, by a first computer-implemented agent that manages a first service provided by an entity, a computer resource to acquire from a cloud resource system for the first service, and first data comprising i) a first time period within which to acquire the computer resource and ii) a first urgency of the computer resource for the first service;
posting, to a message queue for the first computer-implemented agent and a second computer implemented agent both of which a) are requesting access to the computer resource on the cloud resource system and b) manage corresponding services provided by the entity, the first data;
accessing, from the message queue, second data of the second computer-implemented agent comprising i) a second time period within which the second computer-implemented agent should acquire the computer resource for a second service provided by the entity, and ii) a second urgency of the computer resource for the second service;
determining, by the first computer-implemented agent and using the first data and the second data, whether to withdraw a first request for the computer resource;
in response to determining to not withdraw the first request for the computer resource for the first service, determining an updated request for the computer resource using the first data and the second data; and
upon acceptance of the updated request for the computer resource, acquiring the computer resource for use by the first service.

16. The system of claim 15, wherein the operations comprise:
sending, to the cloud resource system and using data indicating the computer resource for the first service, the first request for the computer resource for use by the first service; and
in response to sending the first request for the computer resource for the first service, receiving a notification that the second computer-implemented agent that manages the second service provided by the entity requested the computer resource for the second service.

17. The system of claim 16, wherein the operations comprise:
continuously monitoring a current status of resource utilization for the first service; and
in response to determining that the current status of resource utilization satisfies a threshold, sending the first request for the computer resource to the cloud resource system.

18. The system of claim 15, wherein the operations comprise:
determining, by the first computer-implemented agent and using the first data and the second data, whether to withdraw the first request for the computer resource; and
in response to determining to withdraw the first request for the computer resource for the first service, determining to not post an additional message to the message queue and to remove the first request for the computer resource from the cloud resource system.

19. The system of claim 15, wherein the operations comprise:
determining, by the first computer-implemented agent, a behavior cooperation value of the first computer-implemented agent using i) the first time period within which to acquire the computer resource, ii) the first urgency of the computer resource for the first service, and iii) a cost change between a cost value in a current round of negotiation and a cost value in a previous round of negotiation for the computer resource.

20. The system of claim 15, wherein the operations comprise:
determining, by the first computer-implemented agent, whether a threshold time period within which to acquire the computer resource is satisfied, wherein the first time period was initially determined using the threshold time period; and
in response to determining that the threshold time period is satisfied, terminating negotiation for acquiring the computer resource.

21. The system of claim 15, wherein the operations comprise:
minimizing an overall cost incurred within the entity using the first data and the second data.
